(19) United States
(12) Patent Application Publication
(10) Pub. No.: US 2016/0144441 A1
(43) Pub. Date: May 26, 2016

(54) LOW HEAT FLUX MEDIATED CLADDING OF SUPERALLOYS USING CORED FEED MATERIAL

(71) Applicant: Siemens Energy, Inc., Orlando, FL (US)

(72) Inventors: Gerald J. Bruck, Titusville, FL (US); Ahmed Kamel, Orlando, FL (US)

(21) Appl. No.: 15/008,893

(22) Filed: Jan. 28, 2016

Related U.S. Application Data
(63) Continuation-in-part of application No. 13/754,983, filed on Jan. 31, 2013.
Application No. 13/754,983 is a continuation-in-part of application No. 13/755,145, filed on Jan. 31, 2013, now Pat. No. 9,272,363.
Application No. 13/755,145 is a continuation-in-part of application No. 14/341,888, filed on Jul. 28, 2014.

(51) Int. Cl. B23K 9/04; B23K 35/30; B23K 35/36; B23K 35/368; B23K 9/23; B23K 35/02

(52) U.S. Cl. CPC B23K 9/04; B23K 9/23; B23K 35/0266; B23K 35/3602; B23K 35/3605; B23K 35/3607; B23K 35/3608; B23K 35/361; B23K 35/368; B23K 35/3033; B23K 35/304

(57) ABSTRACT

Methods are disclosed for melting a cored feed material (31) using a low heat input process. The feed material may be a sheath (34) consisting essentially of pure nickel, nickel-chromium, or nickel-chromium-cobalt, containing a powdered core material (36) having a powdered alloy material (42) and powdered flux material (38) which, when melted, form a desired superalloy material. Flux materials for use with the methods are disclosed. The process may be a cold metal transfer process wherein the feed material is oscillated at greater than 130 oscillations per second.

### CROSS REFERENCE TO RELATED INVENTIONS

This application is a continuation-in-part of U.S. patent application Ser. No. 13/754,983 filed on 31 Jan. 2013 titled “Cladding of Alloys Using Flux and Metal Powder Cored Feed Material” and published as US 2014/0209577 A1 on 31 Jul. 2014 (attorney docket number 2012P28299US), incorporated by reference herein.

This application is also a continuation-in-part of U.S. patent application Ser. No. 13/755,145 filed on 31 Jan. 2013 titled “Hybrid Laser Plus Submerged Arc or Electroslag Cladding of Superalloys” and published as US 2014/0209571 A1 on 31 Jul. 2014 (attorney docket number 2012P28298US), incorporated by reference herein.

This application is also a continuation-in-part of U.S. patent application Ser. No. 14/341,888 filed on 28 Jul. 2014 titled “Flux for Laser Welding” and published as US 2015/0027993 A1 on 29 Jan. 2015 (attorney docket number 2013P12177US01), incorporated by reference herein.

### FIELD OF THE INVENTION

Embodiments of the invention relate generally to the field of metals joining, and more particularly to the welding clad buildup and repair of superalloy materials using a hollow cored feed material containing powdered flux and powdered metal with a cold metal transfer process.

### BACKGROUND OF THE INVENTION

Welding processes vary considerably depending upon the type of material being welded. Some materials are more easily welded under a variety of conditions, while other materials require special processes in order to achieve a structurally sound joint without degrading the surrounding substrate material.

Common arc welding often utilizes a consumable electrode as the feed material. In order to provide protection from the atmosphere for the molten material in the weld pool, an inert cover gas or a flux material may be used when welding many alloys including, e.g. steels, stainless steels, and nickel based alloys. Inert and combined inert and active gas processes include gas metal arc welding (GMAW) (also known as metal inert gas (MIG) and metal active gas (MAG)). Flux protected processes include submerged arc welding (SAW) where flux is commonly fed, flux cored arc welding (FCAW) where the flux is included in the core of the electrode and shielded metal arc welding (SMAW) where the flux is coated on the outside of the filler electrode.

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair and it is commonly accomplished using a manual gas tungsten arc welding (GTAW) process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

FIG. 3 is a conventional chart illustrating the relative weldability of various alloys as a function of their aluminum and titanium content. Alloys such as Inconel® 718 which have relatively lower concentrations of these elements, and consequentially relatively lower gamma prime content, are considered relatively weldable, although such welding is generally limited to low stress regions of a component. Alloys such as Inconel® 939 which have relatively higher concentrations of these elements are generally not considered to be weldable, or can be welded only with the special procedures discussed above which increase the temperature/ductility of the material and which minimize the heat input of the process. A dashed line 80 indicates a border between a zone of weldability below the line 80 and a zone of non-weldability above the line 80. The line 80 intersects 3 wt. % aluminum on the vertical axis and 6 wt. % titanium on the horizontal axis. Within the zone of non-weldability, the alloys with the highest aluminum content are generally found to be the most difficult to weld. Furthermore, as new and higher alloy content superalloys continue to be developed, the challenge to develop commercially feasible joining processes for superalloy materials continues to grow.

It is also known to utilize selective laser melting (SLM) or selective laser sintering (SLS) to melt a thin layer of superalloy powder particles onto a superalloy substrate. The melt pool is shielded from the atmosphere by applying an inert gas, such as argon, during the laser heating. These processes tend to trap the oxides (e.g. aluminum and chromium oxides) that are adherent on the surface of the particles within the layer of deposited material, resulting in porosity, inclusions and other defects associated with the trapped oxides. Post process hot isostatic pressing (HIP) is often used to collapse these voids, inclusions and cracks in order to improve the properties of the deposited coating.

A number of companies have disclosed other types of processes. An example is a low heat input process known as cold metal transfer (“CMT”) welding to weld or clad superalloys. For example, General Electric and United Technologies have taught the use of CMT welding without substrate heating and with substrate heating respectively (Pezzutti U.S. 20130082446A1 and Rose U.S. 20130326877A1). Rose includes pre-weld heat treatments and post-weld heat treatments of the substrate (before and after welding) in their method.

The CMT process was developed by Fronius International GMBH Austria and is a variation of short arc gas metal arc welding wherein the wire is caused to move toward and away from the weld pool at a relatively rapid rate (e.g. between 10-130 times/sec.). With an arc established, a molten droplet forms at the end of the wire. Then forward motion of the wire to the weld pool results in a short circuit. The current rise is controlled and backward wire motion is then synchronized with short circuiting to help propel the droplet of molten filler wire to the deposit in a highly controlled manner. Low heat input, low base metal melting, small heat affected zone and little spatter results. To the knowledge of the present inventor, flux materials have not been used when welding superalloy materials with CMT processing.

The small heat affected zone and low residual stress resulting from such a low heat input process is believed to reduce the propensity of the deposit to crack both upon deposition and during commonly required post weld heat treatment. Nonetheless, CMT work on Rene 80 by Rush et al. has shown cracking to be sensitive to the level of welding power (Rush, M. T. et al., an Investigation into Cracking in Nickel-Base Superalloy Repair Welds, Advanced Materials Research, 2010, Vol. 89-91, pp. 467-472). Average crack lengths increased from about 300 μm at 2.25 kW to about 600 μm at 5.5 kW for large grain size material and about 250 μm at 2.25 kW to about 350 μm at 5.5 kW for small grain size material (irrespective of travel speed). So, the reduced heat input possible with CMT can reduce cracking, but it does not eliminate cracking.

### BRIEF DESCRIPTION OF THE DRAWINGS

Embodiments are explained in the following description in view of the drawings that show:

FIGS. 1A-1D illustrate apparatus and steps in a known cold metal transfer process.

FIGS. 2A-2B illustrate a cladding process using a cored filler wire and a cold metal transfer process, in accordance with an embodiment of the present invention.

FIG. 3 is a prior art chart illustrating the relative weldability of various superalloys.

### DETAILED DESCRIPTION OF THE INVENTION

The inventor has recognized that a practical limitation in application of CMT with superalloys is that superalloy wire is very difficult to manufacture and is very expensive. Superalloys are inherently strong and therefore difficult to draw into wire form. They are also prone to cold working (strengthening by dislocation generation) during the drawing process. Furthermore, some superalloys readily form high temperature oxides during initial rod casting which, if left in wire subsequently processed from such material, results in inferior weld properties. U.S. Pat. No. 8,466,389 to Smashey teaches use of directional solidification in investment or continuous casting of rods to float oxide inclusions (e.g. hafnium, aluminum, and perhaps titanium oxides) to the surface where they can be removed. Such rods can be extruded into clean superalloy wire, but the overall process to create spools of reasonable lengths of weld wire for CMT would have been disadvantageous and practically unworkable from an economic standpoint, as it would require special equipment and be very expensive.

The present inventor has also recognized the use of a flux during a low heat input process (such as CMT or TIP TIG processing) helps counteract the increase in crack length observed with increasing wattage, as reported in Rush et al. In an embodiment of the present invention, the use of a flux therefore allows for increased power CMT processing without the associated increase in crack lengths. The flux may serve to either (1) slow the cooling process, allowing for higher wattages to be employed during CMT processing, as slower cooling will reduce the stress intensities and propensity for cracking, or (2) reduce the overall heat of the CMT process, despite increases in wattage, by using a flux designed to keep the entire process cooler.

Heat input can be defined for arc welding as volts times amps divided by travel speed or by volume of weld metal deposited or by energy used per unit weld bead length (aka power used times arc time per unit weld bead length). For gas tungsten arc welding heat input ranges between about 0.5 and 1.5 kilojoules per millimeter (kJ/mm). For conventional gas metal arc welding the range is about 0.2 to 1.0 kJ/mm. For advanced short circuiting gas metal arc welding the range is about 0.1 to 0.6 kJ/mm. As used herein, a heat input range of 0.05 to 0.6 kJ/mm is what is referred to as a low heat input process. The parent patent application US 2014/0209577 A1 discloses a process whereby a readily extrudable cored wire having disposed therein a powdered core material may be used successfully to deposit the most difficult to weld superalloy materials. That document also discloses that the powdered core material may advantageously utilize a powdered flux material during a melting and re-solidifying process. In embodiments of the present invention, methods are disclosed for depositing a desired superalloy using a cored wire with a low heat input welding process such as cold metal transfer welding, TIP TIG, pulsed arc welding, or a low energy beam process.

The flux material is effective to provide energy trapping, impurity cleansing, atmospheric shielding, bead shaping, and cooling temperature control in order to accomplish crack-free joining of superalloy materials without the necessity for high temperature hot box welding or the use of a chill plate or the use of inert shielding gas. While various sub-elements of the present embodiments have been known in the welding industry for decades, the present inventors have innovatively developed a combination of steps for a superalloy cladding process that solves the long-standing problem of cracking of these materials.

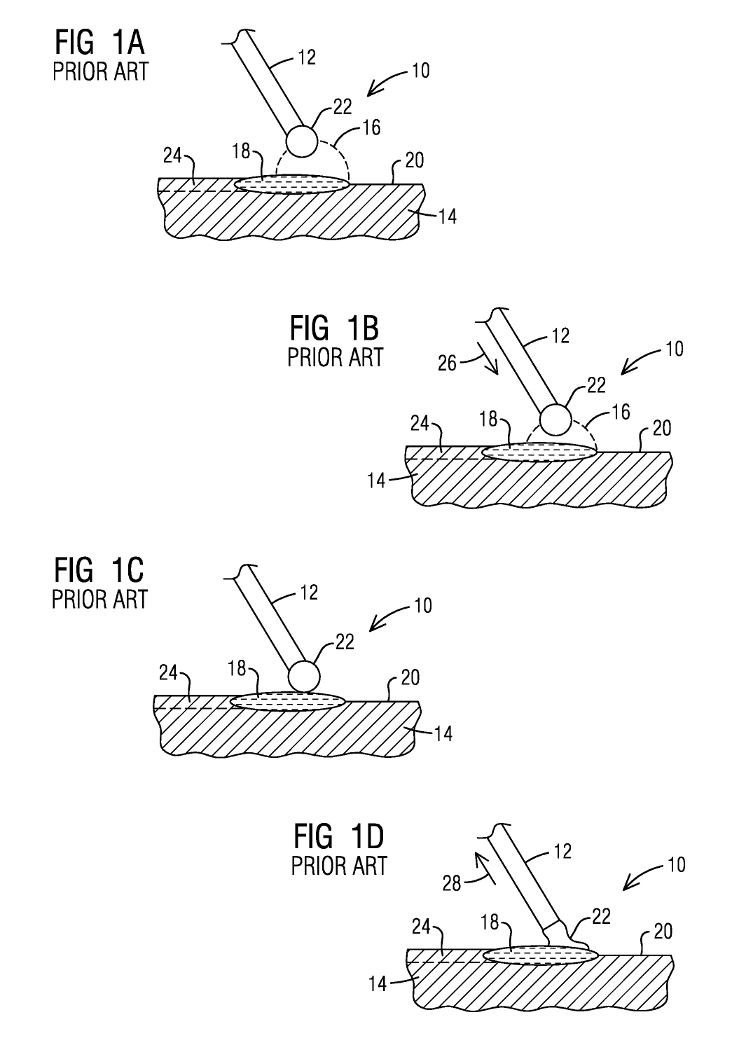

FIG. 1A-1D illustrate basic apparatus and steps in a known cold metal transfer process 10. In FIG. 1A, a consumable electrode 12 approaches an electrically conductive substrate 14, establishing an arc 16 that melts a melt pool 18 on a surface 20 of the substrate and creates a melt drop 22 of alloy filler material on the electrode tip. The electrode 12 is also progressing in a direction of welding from left to right in the figure, and a solidified deposit 24 (as discussed more fully below) is illustrated on the substrate 14. In FIG. 1B the consumable electrode 12 is advanced 26 toward the melt pool 18. In FIG. 10 the melt drop 22 touches the melt pool 18, extinguishing the arc and causing a short circuit. Spiking of the electrical current is mitigated during the short circuit by a controller (not shown). In FIG. 1D the electrode 12 is retracted 28 and the melt drop 22 adheres to the melt pool. This pulls the melt drop 22 off of the electrode 12 into the melt pool 18 by surface tension, thus adding the melt drop as alloy filler material to the melt pool 18. As the electrode 12 progresses left to right, the melt pool 18 cools and solidifies to form the deposit 24. This process is conducted under an inert cover gas to protect the molten and cooling material from the oxidizing effect of air. This cold metal transfer process 10 minimizes spatter and excess heating compared to other arc welding techniques, while providing fast deposition rates.

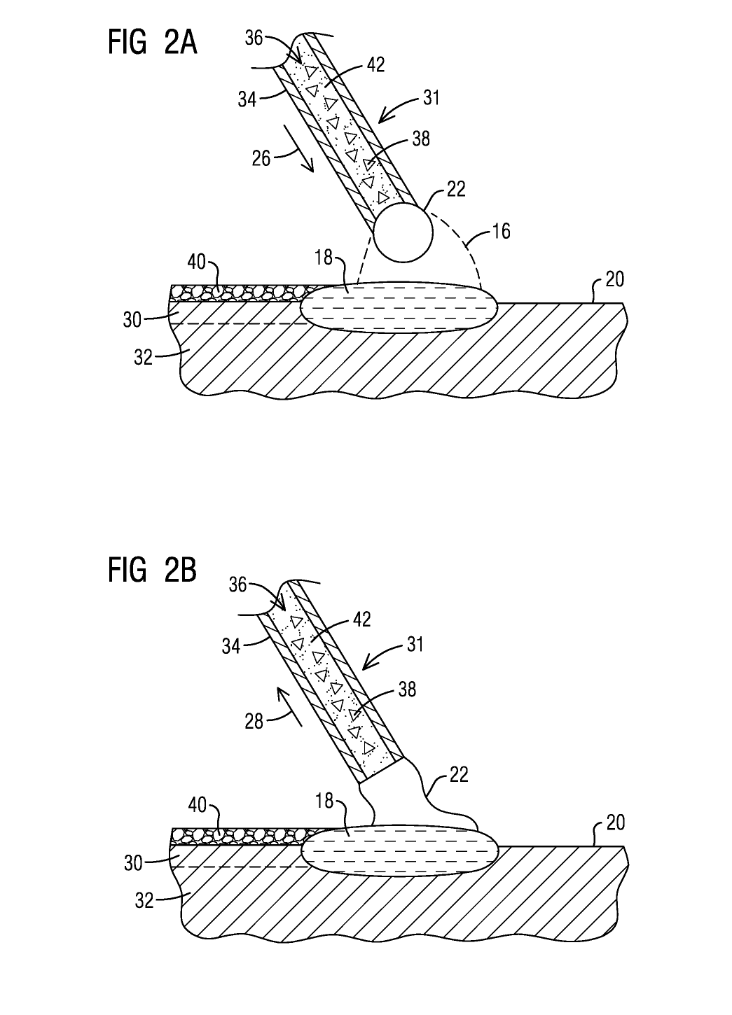

FIGS. 2A-2B illustrate an additive cold metal transfer embodiment of the present invention for depositing superalloy material. Similar to the process described in FIGS. 1A-1D, the process of FIGS. 2A-2B utilize an oscillating feed material to deposit drops of molten filler material 22 into a weld pool 18, as described more fully below. In FIGS. 2A-2B, a cladding layer of superalloy material 30 is deposited onto a surface 20 of a superalloy substrate 32 using a filler or feed material in the form of electrode 31. In this embodiment, the electrode 31 has a form of a cored wire or strip material including a hollow metal sheath 34 filled with a powdered core material 36. The powdered core material 36 includes a powdered alloy material 42 and may also include a powdered flux material 38.

The sheath 34 and powdered core material 36 are advantageously selected such that the resulting layer of cladding material 30 has the composition of a desired superalloy material. The sheath may be only an extrudable subset of elements of a composition of elements defining the desired superalloy material, and the powdered core material includes elements that complement the elements in the sheath to complete the composition of elements defining the desired superalloy material. The sheath and the powdered alloy material are combined in the melt pool 18 to form a layer of cladding 30 of the desired superalloy material. The flux material 38 produces a layer of slag 40 that protects, shapes and thermally insulates the layer of cladding material 30 and eliminates or minimizes the need for an inert cover gas. The slag and melt pool cool and solidify together, and the slag is then removed to reveal the deposited alloy.

While it is difficult or impossible to form some superalloy materials into wire or strip form, materials such as pure nickel or nickel-chromium or nickel-chromium-cobalt are readily available in those forms. Advantageously, the sheath 34 is formed of a material that can be conveniently formed into a hollow shape, such as pure nickel or nickel-chromium or nickel-chromium-cobalt, and the powdered material 36 is selected such that a desired superalloy composition is formed when the filler material is melted. The sheath 34 in an embodiment contains sufficient nickel (or cobalt) to achieve the desired superalloy composition, thus the solid to solid ratio of sheath verses powdered core material weights may be maintained at a ratio of 3:2, for example. The heat of the arc melts the electrode 31 and forms a layer of the desired superalloy material 30 covered by a layer of slag 40. Powdered flux material 38 may be provided in the powdered core material 36 (for example 25% of the core volume) or it may be pre-placed or deposited (not shown) onto the surface 20 of the substrate 32, or the electrode 31 may be coated with flux material, or any combination of these alternatives. A supplemental powdered metal material may also be added to the melt pool (not shown) by being pre-placed on the surface 20 of the substrate 32 or by being directly fed into the melt pool 18 during the step of melting.

In FIG. 2A, an arc 16 is present between the electrode 31 and the melt pool 18. In FIG. 2B the arc is extinguished when the melt drop 22 touches the melt pool 18. The electrode 31 may be automatically advanced 26 toward and retracted 28 away from the melt pool 18 multiple times per second—for example at least 10 times per second in some embodiments and up to 130 times per second in some embodiments. In other embodiments which include a flux 38, the electrode may be oscillated more than 130 times per second due to the stabilizing action of the flux 38 and slag 40. The oscillations create turbulence and forced convection in the melt pool 18 that thoroughly mix the melted sheath and core materials before solidification.

TIP TIG is a low heat input process utilizing a non-consumable (e.g. tungsten) electrode to melt an oscillating feed material electrode. For embodiments of the present invention where the low heat input process used is a TIP TIG process, the feed material electrode 31 may be oscillated left and right, perpendicular to a progression direction of the weld seam or in other orientations in order to achieve a mixing action similar to that achieved by the process of FIGS. 2A-2B.

One embodiment of a filler material electrode 31 is formulated to deposit alloy 247 material as follows:

sheath solid volume is about 60% of total metallic solid volume and is pure Ni;

core metal powder volume is about 40% of total metallic solid volume including sufficient Cr, Co, Mo, W, Al, Ti, Ta, C, B, Zr and Hf; that when melted together and mixed with the pure nickel from the sheath, produces alloy 247 composition of nominal weight percent 8.3 Cr, 10 Co, 0.7 Mo, 10 W, 5.5 Al, 1 Ti, 3 Ta, 0.14 C, 0.015 B, 0.05 Zr and 1.5 Hf; and

core flux powder volume represents additional, largely non-metallic, wire volume possibly about equal in size to the metal powder volume and includes alumina, fluorides and silicates in a 35/30/35 ratio. The mesh size range of the flux is such as to distribute uniformly within the core metal powder. Flux and metal powder may alternately be provided as composite powder particles.

As for the flux itself, parent patent application US 2015/0027993 A1 discloses flux compositions for use in the repair and/or joining of the most difficult to weld superalloy materials and other alloy materials. The reference is incorporated by reference in its entirety as exemplar fluxes for use in the present disclosure.

Typical powdered prior art flux materials have particle sizes ranging from 0.5-2 mm, for example. However, the powdered alloy material 42 may have a particle size range (mesh size range) of from 0.02-0.04 mm or 0.02-0.3 mm or other sub-range therein. In the embodiment of FIGS. 2A-2B, it may be advantageous for the powdered alloy material 42 and the powdered flux material 38 to have overlapping mesh size ranges, or to have the same mesh size range in order to facilitate mixing and feeding of the powders and to provide improved flux coverage during the melting process. In various embodiments, the flux material may be electrically conductive (electroslag) or not (submerged arc), and it may be chemically neutral or additive. The filler material may be preheated to reduce process energy required. A semi-conductive or non-conductive slag may be formed. These slags have the advantage of containing the arc within the precise weld zone, and preventing the arc from traveling or jumping laterally or axially. In order to produce a non-conductive or semi-conductive slag, the flux composition may include compounds which have an electrical insulative resistivity. The flux material may melt to form a slag having a specific conductivity of no more than 9 mho/com or between 1 and 9 mho/cm. To express electrical insulating properties, volume resistivity or dielectric strength is widely used as an index. The flux material therefore includes composition(s) having a dielectric strength of at least 11 kV/mm.

Advantages of the flux composition(s) disclosed are that they advantageously serve to control the arc and quiet the weld pool. The presence of the melted flux and slag quiets weld pool oscillations caused by oscillations of the feed material and/or energy source, thereby allowing higher oscillation rates during deposit than previously achieved using prior low heat input processing. Embodiments include a low heat input processing wherein the oscillation rate (the rate in which the feed material is advanced and retracted from the substrate) is greater than 130 oscillations per second, and as high as 160 oscillations per second. In other embodiments, the oscillation rate is between 135-155 oscillations per second, or between 150-160 oscillations per second. Oscillation rates of lower than 130 oscillations per second may also be used.

Benefits to the disclosed flux is that it helps to ensure that the arc does not wander when struck. This is because the flux (and corresponding slag) is retained around the edges. The use of the flux material ensures slag coverage in the trail and is sufficiently thick to assist in shaping the weld pool. The use of a flux material also provides shielding thereby reducing or eliminating the need for inert or partially inert gas used in CMT processing. The flux material further serves the function of cleansing impurities (scavenging tramp elements), and the slag serves to promote cooling or preserving of heat as the weld pool solidifies, as appropriate for the metal desired to be deposited. In an embodiment, the flux includes the compositions disclosed in Patent Publication US 2015/0027993, which is incorporated herein by reference.

To generate shield gas, carbonates such as CaCO₃, SrCO₃, and BaCO₃ would be particularly useful to generate CO₂, which is used with CMT processing—either as a shield gas alone or combined with other inert gases such as argon or helium. Metal halides may also be included to generate fluorine, chlorine, or bromine gas and to supplement metallic additions. Examples include AlF₃ and Al₂Cl₆. Hydrogen halides may also be used to generate shielding gases. Metal hydrides may similarly contribute shielding gases as well as metallic additions. Examples include TiH_{1.7}, ZrH₂, CrH, AlH₃, and HfH₂.

In some additional embodiment, flux materials of the present disclosure include:

| | |
|---|---|
| 5-60% by weight of | optically transmissive constituent(s) |
| 10-70% by weight of | viscosity/fluidity enhancer(s) |
| 0-40% by weight of | shielding agent(s) |
| 5-30% by weight of | scavenging agent(s) |
| 0-7% by weight of | vectoring agent(s). |

In some embodiments flux materials of the present disclosure include:

| | |
|---|---|
| 20-40% by weight of | optically transmissive constituent(s) |
| 15-35% by weight of | viscosity/fluidity enhancer(s) |
| 5-25% by weight of | shielding agent(s) |
| 10-25% by weight of | scavenging agent(s) |
| 0-5% by weight of | vectoring agent(s). |

In some embodiments flux materials of the present disclosure include:

| | |
|---|---|
| 5-60% by weight of | metal oxide(s) |
| 10-70% by weight of | metal fluoride(s) |
| 5-40% by weight of | metal silicate(s) |
| 0-40% by weight of | metal carbonate(s). |

In some embodiments flux materials of the present disclosure include:

| | |
|---|---|
| 5-40% by weight of | Al₂O₃, SiO₂, and/or ZrO₂ |
| 10-50% by weight of | metal fluoride(s) |
| 5-40% by weight of | metal silicate(s) |
| 0-40% by weight of | metal carbonate(s) |
| 15-30% by weight of | other metal oxide(s). |

In some embodiments flux materials of the present disclosure include:

| | | |
|---|---|---|
| 5-60% by weight of | at least one of: | Al₂O₃ |
| | | SiO₂ |
| | | Na₂SiO₃ |
| | | K₂SiO₃ |
| 10-50% by weight of | at least one of: | CaF₂ |
| | | Na₃AlF₆ |
| | | Na₂O |
| | | K₂O |
| 1-30% by weight of | at least one of: | CaCO₃ |
| | | Al₂(CO₃)₃, |
| | | NaAl(CO₃)(OH)₂ |
| | | CaMg(CO₃)₂ |
| | | MgCO₃ |
| | | MnCO₃ |
| | | CoCO₃ |
| | | NiCO₃ |
| | | La₂(CO3)₃ |
| 15-30% by weight of | at least one of: | CaO |
| | | MgO |
| | | MnO |
| | | ZrO₂ |
| | | TiO₂ |
| 0-5% by weight of | at least one of: | Ti |
| | | Al |
| | | TiO₂ |
| | | CaTiSiO₅. |

In some embodiments the flux materials of the present disclosure include:

| | | |
|---|---|---|
| 5-40% by weight of | | Al₂O₃ |
| 10-50% by weight of | | CaF₂ |
| 5-30% by weight of | | SiO₂ |
| 1-30% by weight of | at least two of: | CaCO₃ |
| | | Al₂(CO₃)₃, |
| | | NaAl(CO₃)(OH)₂ |
| | | CaMg(CO₃)₂ |
| | | MgCO₃ |
| | | MnCO₃ |
| | | CoCO₃ |
| | | NiCO₃ |
| | | La₂(CO3)₃ |
| 15-30% by weight of | at least one of: | CaO |
| | | MgO |
| | | MnO |
| | | ZrO₂ |
| | | TiO₂ |
| 0-5% by weight of | at least one of: | Ti |
| | | Al |
| | | TiO₂ |
| | | CaTiSiO₅. |

In some embodiments the flux materials of the present disclosure include:

| | | |
|---|---|---|
| 5-40% by weight of | | Al₂O₃ |
| 10-50% by weight of | | CaF₂ |
| 5-30% by weight of | | SiO₂ |
| 1-30% by weight of | at least one of: | CaCO₃ |
| | | MgCO₃ |
| | | MnCO₃ |
| 15-30% by weight of | at least two of: | CaO |
| | | MgO |
| | | MnO |
| | | ZrO₂ |
| | | TiO₂ |
| 0-5% by weight of | at least one of: | Ti |
| | | Al |
| | | TiO₂ |
| | | CaTiSiO₅ |
| | | Al₂(CO₃)₃ |
| | | NaAl(CO₃)(OH)₂. |

In some embodiments the flux materials of the present disclosure include:

| | | |
|---|---|---|
| 5-30% by weight of | | Al₂O₃ |
| 10-50% by weight of | | CaF₂ |
| 5-30% by weight of | | SiO₂ |
| 1-30% by weight of | at least one of: | CaCO₃ |
| | | Al₂(CO₃)₃, |
| | | NaAl(CO₃)(OH)₂ |
| | | CaMg(CO₃)₂ |
| | | MgCO₃ |
| | | MnCO₃ |
| 15-30% by weight of | at least one of: | CaO |
| | | MgO |
| | | MnO |
| | | ZrO₂ |
| | | TiO₂ |
| 1-5% by weight of | at least one of: | Ti |
| | | Al |
| | | TiO₂ |
| | | CaTiSiO₅. |

In some embodiments the flux materials of the present disclosure include zirconia (ZrO₂) and at least one metal silicate, metal fluoride, metal carbonate, metal oxide (other than zirconia), or mixtures thereof. In such cases the content of zirconia is often greater than about 7.5 percent by weight, and often less than about 25 percent by weight. In other cases the content of zirconia is greater than about 10 percent by weight and less than 20 percent by weight. In still other cases the content of zirconia is greater than about 3.5 percent by weight, and less than about 15 percent by weight. In still other cases the content of zirconia is between about 8 percent by weight and about 12 percent by weight.

In some embodiments the flux materials of the present disclosure include a metal carbide and at least one metal oxide, metal silicate, metal fluoride, metal carbonate, or mixtures thereof. In such cases the content of the metal carbide is less than about 10 percent by weight. In other cases the content of the metal carbide is equal to or greater than about 0.001 percent by weight and less than about 5 percent by weight. In still other cases the content of the metal carbide is greater than about 0.01 percent by weight and less than about 2 percent by weight. In still other cases the content of the metal carbide is between about 0.1 percent and about 3 percent by weight.

In some embodiments the flux materials of the present disclosure include at least two metal carbonates and at least one metal oxide, metal silicate, metal fluoride, or mixtures thereof. For example, in some instances the flux materials include calcium carbonate (for phosphorous control) and at least one of magnesium carbonate and manganese carbonate (for sulfur control). In other cases the flux materials include calcium carbonate, magnesium carbonate and manganese carbonate. Some flux materials comprise a ternary mixture of calcium carbonate, magnesium carbonate and manganese carbonate such that a proportion of the ternary mixture is equal to or less than 30% by weight relative to a total weight of the flux material. A combination of such carbonates (binary or ternary) is beneficial in most effectively scavenging multiple tramp elements.

All of the percentages (%) by weight enumerated above are based upon a total weight of the flux material being 100%.

Flux materials which could be used include commercially available fluxes such as those sold under the names Lincolnweld P2007, Bohler Soudokay NiCrW-412, ESAB OK 10.16 or 10.90, Special Metals NT100, Oerlikon OP76, Sandvik 50SW or SAS1. The flux particles may be ground to a desired smaller mesh size range before use. Flux materials known in the art may typically include alumina, fluorides and silicates. Embodiments of the processes disclosed herein may advantageously include metallic constituents of the desired cladding material, for example chrome oxides, nickel oxides or titanium oxides. Any of the currently available iron, nickel or cobalt based superalloys that are routinely used for high temperature applications such as gas turbine engines may be joined, repaired or coated with the inventive process, including those alloys mentioned above.

In some embodiments, the flux may be a flux that includes a cooling agent. One exemplar cooling agent may be a set of materials which participate in an endothermic process. This endothermic process may be, for example, an endothermic reaction such as an endothermic decomposition, or a heat absorptive phase change or transition from a gas to plasma. If the endothermic process is a reaction, the cooling agent may be a set of reactants added to the powdered flux material 38 before or at the time of melting which combine to form products in an endothermic reaction. Because the reaction is endothermic, it will draw heat away from the hot melt pool 18, thereby speeding the cooling process.

Fluxes comprised of carbonates (e.g. calcium carbonate (CaCO₃)), would absorb heat and form oxides and gases (e.g. CaO and CO₂ (and CO)) in endothermic decomposition reactions thereby both removing heat from the deposit and forming a shielding gas. Ammonium nitrite may also be included in the flux as it may absorb heat and decompose to yield nitrogen (somewhat shielding) and water vapor. Solid salts may also be included in the flux as they absorb heat upon melting during liquid slag formation. Also, to the extent that the laser interacts with gas molecules to form a plasma such dissociation is endothermic. Processing in an atmosphere containing methane and water could also chill the deposit by the reaction CH₄+H₂O⇄CO+3 H₂, because it is a reaction that takes place at relatively high temperatures (around 1100 C), which forms a gas (H₂—also good for shielding), and which uses nickel as a catalyst (which may be a constituent in the metallic glass). The release of H₂ in this reaction (or due to other reactions of flux materials) in the presence of iodine (I₂) would, at elevated temperatures, also absorb heat and produce hydrogen iodide (HI).

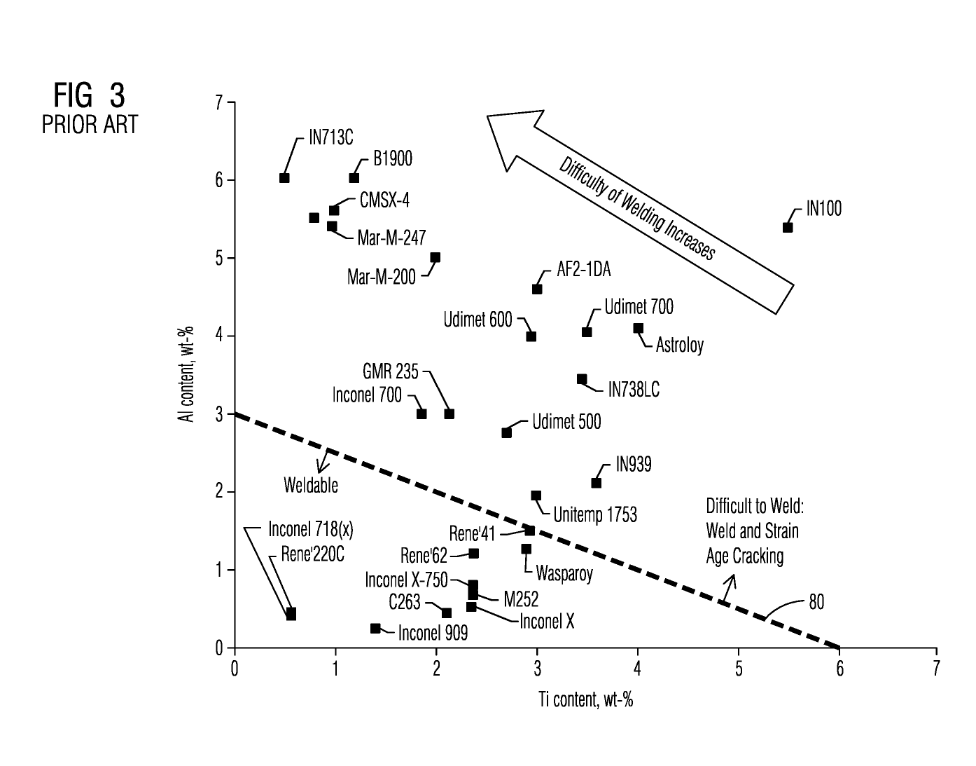

Another exemplar cooling agent may be a gas generating agent (“GGA”) included in the powdered flux material 18. This may be any substance or group of substances that rapidly form gases, such as substances that sublimate at or above room temperature, such as solid CO₂ (CO₂₍ₛ₎) or iodine (I₂₍ₛ₎), or a reactive material such as a carbonate which forms CO₂. In an embodiment involving solid CO₂ or iodine crystals, the solid is injected either in the layer of powdered alloy material, or the layer of powdered slag material, or both, either at the time of melting or just before. In the embodiment of FIG. 3, when the powdered alloy material and the powdered flux material are melted, the powdered flux material's gas generating agent forms gas bubbles 36 which rise through the melt pool 30. The bubbles create voids and narrow, thin channels 38 through the melt pool 30. In areas where these thin channels 38 are present, the melt pool 30 cools more quickly so as to form the layer of metallic glass 14. This is because heat is conducted away more rapidly from a thin material than a thick material. The resulting pores augment the thermal insulating properties and mechanical compliance of the resulting layer of metallic glass.

The flux may also have properties which allow it to radiate heat. The powdered flux material 38 may include metal elements having higher thermal conductivity, as higher thermal conductivity metals in the flux (and corresponding layer of slag 40) will more rapidly radiate heat away from the melt pool 18. Fluxes of high silica (the metalloid oxide, SiO₂) content relative to alumina (Al₂O₃),or zirconia (ZrO₂) content may enhance heat radiation, for example at least two or three or four times the molar content of silica compared to alumina, or zirconia, or the combination of alumina and zirconia.

Advantages of the disclosed processes over known CMT processing include: high deposition rates and thick deposit in each processing layer due to the increased wattages that may be used, improved shielding that extends over the hot deposited metal without the need for inert gas, enhanced cleansing of the deposit of constituents that otherwise lead to solidification cracking, slag formation to shape and support the deposit, a capability to compensate for elemental losses or add alloying elements, and increases in efficiency from a reduction of the time involved in total part building. Incorporation of the flux also reduces residual stresses that otherwise contribute to strain age (reheat) cracking during post weld heat treatments in one of two ways: (1) by using a flux which generates a thermally insulating slag to preserve heat and slow the cooling rate, or (2) by using a cooling flux to reduce the heat of the overall process, thereby reducing the overall temperature change during solidification cooling.

The cold metal transfer process is illustrated as exemplary. Variations on cold metal transfer (CMT) originally developed by Fronius International are known by such names as reciprocating wire feed gas metal arc welding (RWF-GMAW) developed by Edison Welding Institute, controlled short circuit (CSC) developed by Jetline Engineering, micro-mig developed by SKS Systems and active wire process (AWP) developed by Panasonic. Such variations are considered equivalent examples of low heat input weld processing to benefit from the teachings herein. Still alternate technologies that can provide the low alloy melting energy include pulsed gas metal arc welding, pulsed gas tungsten arc welding, pulsed tip tungsten inert gas welding (pulsed TIP TIG), and pulsed energy beams (including for example a laser beam, a particle beam, a charged-particle beam, a molecular beam). The cold metal transfer process is advantageous because of its mechanical mixing of the melt pool by rapid repetitive dipping of the electrode tip, high deposit control and relatively low heat. In addition to welding and cladding, it can form an extensive variety of additive deposition forms and wall growth directions. Tip tungsten inert gas welding may also be advantageous because of superimposed mechanical oscillation of feed wire helping to agitate the molten weld pool and promote oxide distribution therein. The on/off switching of the alloy melting energy described herein includes in some embodiments switching between a first energy level (on) and a second energy level (off) that is less than 50% of the first energy level.

Other variations include that the powdered alloy material and/or flux may be selected to be conductive such as to facilitate an electro-slag welding process effective to form the layer of superalloy cladding material.

For embodiments where the heat of melting is provided by an arc, it is common to provide oxygen or carbon dioxide in the flux or shielding gas in order to maintain arc stability. However, the oxygen or carbon dioxide will react with titanium and some of the titanium will be lost as vapor or oxides during the melting process. A present embodiment allows the amount of titanium included in the filler material to be in excess of the amount of titanium desired in the deposited superalloy composition to compensate for this loss. For the example of alloy 247 described above, the amount of titanium included in the core metal powder may be increased from 1% to 3%.

One will appreciate that other alloys, such as stainless steels for example, may be deposited with a similar process where a cored feed material is filled with a powdered core material including powdered flux and powdered metal. The powdered metal may be used to augment the composition of the sheath material to obtain a cladding material of a desired chemistry. For embodiments where there is a loss of material due to vaporization during the melting step, the powdered metal may include an excess of the lost material to compensate for the loss. For example, when alloy 321 stainless steel sheath material is deposited under a shielding gas containing oxygen or carbon dioxide, some of the titanium from the sheath material is lost due to reaction with the oxygen or carbon dioxide. The powdered core material in such an embodiment may include powdered flux including titanium compounds such as titanium oxide and powdered titanium metal to compensate for the loss, thus providing a desired alloy 321 cladding composition.

It is known to increase the fluidity of certain wrought alloy compositions when using them in a casting process. This may be done, for example, by increasing an amount of the silicon of the composition. For example, Type 347 wrought stainless steel, which has a maximum of 1% silicon is available as casting Alloy CF-8C, which may have up to 2% silicon. Similarly, Type 304 stainless steel may contain up to 1% silicon in its composition, but its cast version (CF-8) may have up to 2% silicon. The methods disclosed are suitable for use when depositing feed material which is a fluidity enhanced alloy or otherwise is a highly fluid alloy. This is because as oscillation rates increase with low heat input processing, it can cause an undesirable degree of splatter of the melted deposited alloy. This is an issue which only increases with increasing alloy fluidity. Advantageously, the slag formed in the presently disclosed processes serves to contain the deposited molten droplet and quiet the weld pool, allowing for higher oscillation rates to be achieved in low heat input processing.

An advantage of using higher oscillation rates in processing is that overall processing speed is increased and it is believed that better mixing of the melted powder and sheath material is achieved. For these reasons, the methods disclosed offer an increased processing speed for depositing alloys, and in particular, fluidity enhanced alloys and alloys with greater than 1% silicon.

Repair processes for superalloy materials may include preparing the superalloy material surface to be repaired by grinding as desired to remove defects, cleaning the surface, then pre-placing or feeding a layer of powdered material containing flux material onto the surface, then traversing an energy beam across the surface to melt the powder and an upper layer of the surface into a melt pool having a floating slag layer, then allowing the melt pool and slag to solidify. The melting functions to heal any surface defects at the surface of the substrate, leaving a renewed surface upon removal of the slag typically by known mechanical and/or chemical processes. The sheath 34, as well as any metal contribution from the powdered core material's flux material (which may be neutral or additive), are combined in the melt pool to produce a cladding layer having a desired composition.

If desired, the feed material may be preheated (e.g. electrically) to reduce the required arc energy. While pre-heating of the substrate is not necessarily required to obtain acceptable results, it may be desired to apply heat to the substrate and/or to the feed material and/or the powder prior to the melting step in some embodiments, such as to increase the ductility of the substrate material and/or to reduce energy otherwise required to melt the filler. Similarly, a chill fixture could optionally be used for particular applications, which in combination with the low heat input process can minimize stresses created in the material as a result of the melting process. Furthermore, the processes described herein may negate the need for an inert shielding gas, although supplemental shielding gas may be used in some applications if preferred.

In accordance with other embodiments, mixed submerged arc welding flux and alloy 247 powder was pre-placed from 2.5 to 5.5 mm depths and demonstrated to achieve crack free laser clad deposits after final post weld heat treatment. Ytterbium fiber laser power levels from 0.6 up to 2 kilowatts have been used with galvanometer scanning optics making deposits from 3 to 10 mm in width at travel speeds on the order of 125 mm/min. Absence of cracking has been confirmed by dye penetrant testing and metallographic examination of deposit cross sections. It will be appreciated that alloy 247 falls within the most difficult area of the zone of non-weldability as illustrated in FIG. 3, thereby demonstrating the operability of the embodiment for a full range of superalloy compositions, including those with aluminum content of greater than 3 wt. %.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of depositing an alloy, the method comprising:
melting a cored feed material to form a melt pool using a heat input of 0.05 to 0.6 kJ/mm; and
allowing the melt pool to cool and solidify to form deposited alloy.

2. The method of claim 1, further comprising:
melting flux material contained within a core of the feed material to form slag over the melt pool;
allowing the melt pool to cool and solidify under and with the slag; and
removing the solidified slag to reveal the deposited alloy.

3. The method of claim 2, further comprising:
melting the cored feed material with a cold metal transfer process;
wherein the melted flux material and slag are effective to quiet weld pool oscillations.

4. The method of claim 3, wherein the cored feed material is oscillated at greater than 130 oscillations per second

5. The method of claim 2, further comprising:
selecting the feed material to comprise a sheath containing a powdered core material, the powdered core material comprising a powdered alloy material and a powdered flux material, the sheath consisting essentially of pure nickel, nickel-chromium, or nickel-chromium-cobalt; wherein:
the powdered core material comprises constituents that complement the sheath to form the deposited alloy as a desired superalloy material when the sheath and powdered core material are melted together.

6. The method of claim 5, wherein the cored feed material is melted using a cold metal transfer process, a reciprocating wire feed gas metal arc welding process, a TIP TIG process, pulsed arc welding, or a low energy beam process.

7. The method of claim 2, wherein the flux material comprises:
5 to 85 percent by weight of a metal oxide, a metal silicate, or both;
10 to 70 percent by weight of a metal fluoride; and
1 to 30 percent by weight of a metal carbonate,
relative to a total weight of the flux material, wherein:
the flux material does not contain substantial amounts of iron; and
the flux material does not contain substantial amounts of Li2O, Na2O or K2O.

8. The method of claim 2, wherein the flux material comprises:
at least one selected from a group consisting of a metal oxide, a metal silicate, a metal fluoride and a metal carbonate; and
a metal carbide.

9. The method of claim 2, wherein the flux material comprises:
at least one selected from a group consisting of a metal oxide, a metal silicate and a metal fluoride; and
at least two metal carbonates.

10. The method of claim 2, wherein the flux material comprises a metal hydride or hydrogen halide.

11. The method of claim 2, wherein the flux material melts to form a slag having a specific conductivity between 1 and 9 mho/cm.

12. The method of claim 2, wherein the powdered flux material comprises a cooling agent effective to remove heat from the melt pool.

13. A method for depositing a desired superalloy composition, the method comprising:
melting a consumable electrode using a low heat input process in the presence of a flux material, wherein:
the consumable electrode comprises a sheath consisting essentially of one of a group of nickel, nickel-chromium, and nickel-chromium-cobalt, the sheath containing a powdered core material; and the sheath and powdered core material comprising elements which, upon melting, form the desired superalloy composition.

14. The method of claim 13, wherein the low heat input process is cold metal transfer welding, a reciprocating wire feed gas metal arc welding process, a TIP TIG process, pulsed arc welding, or a low energy beam process.

15. The method of claim 13, wherein the flux material is a powdered flux material and the powdered core material comprises the powdered flux material and a powdered alloy material.

16. The method of claim 13, wherein the flux material comprises a flux composition comprising:
5 to 85 percent by weight of a metal oxide, a metal silicate, or both;
10 to 70 percent by weight of a metal fluoride; and
1 to 30 percent by weight of a metal carbonate,
relative to a total weight of the flux composition, wherein:
the flux composition does not contain substantial amounts of iron; and
the flux composition does not contain substantial amounts of Li₂O, Na₂O or K₂O.

17. The method of claim 13, wherein the flux material comprises a flux composition comprising:
at least one selected from the group consisting of a metal oxide, a metal silicate and a metal fluoride; and
at least two metal carbonates.

18. The method of claim 13, wherein the flux material comprises a metal hydride or a hydrogen halide.

19. The method of claim 13, wherein the consumable electrode forms a fluidity enhanced alloy comprising greater than 1 wt. % silicon when melted.

20. The method of claim 13, wherein the low heat input process is a cold metal transfer process wherein the consumable electrode is oscillated axially relative to the substrate at a rate greater than 130 oscillations per second.
